(19) United States
(12) Patent Application Publication
(10) Pub. No.: US 2015/0205856 A1
(43) Pub. Date: Jul. 23, 2015

(54) DYNAMIC BROWNIAN MOTION WITH DENSITY SUPERPOSITION FOR ABNORMALITY DETECTION

(71) Applicant: DECISION MAKERS - LEARNING & RESEARCH SIMULATIONS LTD., Shoham (IL)

(72) Inventor: Eyal BRILL, Shoham (IL)

(21) Appl. No.: 14/601,862

(22) Filed: Jan. 21, 2015

Related U.S. Application Data
(60) Provisional application No. 61/929,518, filed on Jan. 21, 2014.
(60) Provisional application No. 62/104,862, filed on Jan. 19, 2015.

(51) Int. Cl. G06F 17/30

(52) U.S. Cl. CPC G06F 17/30598; G06F 17/30958

(57) ABSTRACT

A method for detecting and classifying an event includes the procedure of acquiring a plurality of data-instances, each corresponding to a respective attributes measurement of selected attributes, each including at least one attribute, each being further associated with a respective time-stamp and defining a data point in an attributes space. For each selected data-instance, the distance in the attributes space is determined between a point ‘T_{N}’ corresponding to the selected data-instance and the K^{th} preceding data-point ‘Tₙ₋ₖ’. A distance versus time function is determined from the determined distances and time-stamps associated with each selected data-instance and the occurrence of an event is detected according to a distance threshold of the distances in the distance versus time function. The morphology parameters of the distance versus time function are determined when an event is detected; and the event is classified according to the determined morphology parameters of the distance versus time function.

This application claims benefit of U.S. Provisional Ser. No. 61/929,518, filed 21 Jan. 2014 and U.S. Provisional Ser. No. 62/104,862, filed 19 Jan. 2015 and which applications are incorporated herein by reference. To the extent appropriate, a claim of priority is made to each of the above disclosed applications.

### FIELD OF THE INVENTION

The disclosed technique relates to data analysis in general, and to method designed for detecting abnormal events in industrial control systems.

### BACKGROUND OF THE INVENTION

Analysis of measured data in control systems enables the detection, monitoring, and classification of events, occurring in such systems and, in particular, the detection of infrequent events or hazardous events. It is assumed that infrequent events are suspicious and thus should be detected, classified and generate an alert based thereon (e.g., to allow authorized personal to take proper action). For example, the contamination of a water reservoir is an infrequent event that can be detected and monitored. Failure of distribution lines, transformers, solar panels and the like are also infrequent events that may be detected. Detection of events according to the known in the art method requires the classification of real-time data measurements as either a frequent event or an infrequent event. The infrequent events are reported to the operators of the system. The known in the art methods also require the classification of such events in order to determine if the event is hazard or not.

In general, data measurements are stored in a database (i.e., each measurement is an entry in the database) and may include the measurement of a plurality of attributes. Measurements are stored in a database in a structure of records. A record is a set of measurements from the same sensor unit or from several related units (e.g., sensor units which are located at the same location) and with the same times-tamp. A time-stamp is the time reference when the measurements have been acquired.

Each record in the database includes also a record number or identifier. The record identifier (e.g., a sequential number) is used to identify continuum of the records. The time-stamp on the other hand may be for fixed intervals or based on changes in the data. For example, measurements of electric characteristics of an electricity distribution system may include attributes such as electric current, voltage, phase, frequency, location in the network and the like. In general, the plurality of attributes may be regarded as a multi-dimensional space (i.e., each attribute corresponds to one dimension) and the data entries (i.e., the set of measurements associated with the record) in the database can be regarded as points (i.e., also referred to as data points) in this multi-dimensional space.

An event is a group of records with some common reference. The reference may be time based or any other criteria. The classification of events is performed based on characteristics of the records assigned to the event.

The multi-dimensional attribute space may not be uniformly occupied by data points. Certain regions of the attribute space may be dense while other regions may be sparse. The term dense refers to the number of points per defined region. The dense regions may be regarded as a subset or subsets of data entries according to a similarity or dissimilarity criterion or criteria. For example the number of points located within a given Euclidian distance in the multi-dimensional space is a similarity criterion. As another example, all the entries exhibiting a selected attribute or attributes within a determined range may be regarded as similar entries.

Continuing with the example of an electricity distribution system, the following data entries may be regarded as similar data entries: the current attribute exhibiting values between 10 and 20 Amperes, the voltage attribute exhibiting values between 230 and 250 Volts, the phase attribute exhibiting values between −5 radians to +5 radians and the frequency attribute exhibiting values between 58 and 62 Hertz.

Clustering methods attempt to partition the data entries into subsets, according to selected similarity criteria. In the attribute space, these subsets can be visualized as clusters of points. Some prior art clustering techniques are based on an estimation of a density function of the data points in the attributes space.

The book to Jain Anil K. and Dubes Richard C., entitled “Clustering Methods and Algorithms”, directs to a clustering method in which clusters are identified by searching for regions of high densities, which are referred to as Nodes. Each Node is associated with a cluster center and each point is assigned to a cluster with the closest center. Anil et al. further describes a way to identify Nodes by partitioning the attribute space into non-overlapping cells and determining a histogram (i.e., determining the number of data points in each cell). Cells with relatively high frequency counts are potential cluster centers. The boundaries between clusters fall in the valleys of the histogram.

The Publication to Hinneburg et al entitled “DENCLUE 2.0: Fast Clustering Based on Kernel Density Estimation”, directs to a clustering algorithm in which the probability density in the attribute space is estimated as a function of all data points. The influence of each point is modeled with a Gaussian Kernel. The sum of all kernels gives an estimate of the probability at a given point. A cluster is defined as a local maximum of the estimated density function.

The quality of clustering refers to a measure that describes the ability of a given set of clusters, to allocate each point in the multi dimension space to one of the clusters unambiguously. Literature gives several methods for such a measure. For example the Silhouette index which refers to a method of interpretation and validation of clusters of data.

The publication to Rousseeuw entitled “Silhouettes: a Graphical Aid to the Interpretation and Validation of Cluster Analysis”, directs to a method for graphically representing the clustering validity (i.e., a figure of merit to the assignment of an object to the cluster thereof). According to the method directed to by Rousseeuw, each object in a cluster is assigned an number, s(i), determined according to the distances between the object and other objects in the cluster thereof and the distance between the object the and the objects in the closest cluster to the cluster of the object. A small s(i) indicates a low clustering validity for that object. A large s(i) indicates a high clustering validity for that object.

A Random Walk (RW) is a mathematical formalization of a trajectory. The trajectory consists of a sequence of discrete steps, where the direction and size of each step is random and does not depend on the previous steps. RW is an abstraction for a range of processes observed in complex systems. For example, random Brownian motion of molecules in liquids or gas and the foraging behavior of animals and insects may be represented by RWs. A Gaussian RW is a RW process in which the step size varies according to a normal distribution. More generally, a distributional RW is a RW in which the step size and the step direction is each determined according to a respective known distribution, such as Gaussian distribution or Poisson distribution.

Distance based approaches for detecting anomalies and employing RW distance based metric, are known in the art. The Publication to Nguyen Lu Dang et al entitled “Network Anomaly Detection Using a Commute distance Based Approach” is directed to a distance based method for detecting anomalies in computer network traffic using commute distance. Commute distance is a measure derived from random walk on graph. Random walk on graph is a stochastic process in which the next vertex in the trajectory is randomly selected from the neighbors of the current vertex. The commute distance is the number of random walk steps it takes for reaching from a first vertex to a second vertex and back. The anomaly detection method includes the steps of constructing a mutual K₁ nearest neighbor graph from a dataset, calculating the pair-wise commute distance between any two observations of the dataset, and detecting the top N anomalies by employing a designated pruning technique.

PCT Application publication WO 2012/147078 to Brill entitled “A System and Method for Detecting Abnormal Occurrences”, directs in one embodiment therein, to a method wherein an event is defined as a substantial change or changes over time in the expected values of at least one measured attribute. When the value of the measurements of the attributes are normalized and these measurements are projected onto an attributes space, an attributes signal is determined which represents the Euclidian distance of the current measurement from a preceding k^{th} measurement versus time. K is generally selected such that the distance between the data measurement and the selected K^{th} preceding measurement in the normalized attribute space is minimal. When the value of the attribute signal is above a predetermined threshold, then, an abnormal event is suspected.

The following event detection systems to are known in the art:
CANARY by EPA (https://software.sandia.gov/trac/canary);
MONITOOL by S-SCAN (https://www.s-can.at/text.php?kat=5id=51&langcode=);
Hack by GARDIAN BLUE (http://www.hachhst.com/); and
TAKADU (http://www.takadu.com/).

### SUMMARY OF THE INVENTION

It is an object of the disclosed technique to provide a novel method and system for detecting and classifying events. In accordance with the disclosed technique, there is thus provided a method for detecting and classifying an event. The method includes the procedures of acquiring a plurality of data instances, each corresponding to a respective attributes measurement of selected attributes, each including at least one attribute, each being further associated with a respective time-stamp and defining a data point in an attributes space and for each selected data instance, determining the distance in the attributes space, between a point ‘T_{N}’ corresponding to the selected data instance and the K^{th} preceding data point ‘Tₙ₋ₖ’. The method further includes the procedures of determining a distance versus time function from the determined distances and time-stamps associated with each the selected data instances, detecting the occurrence of an event according to a distance threshold of the distances in the distance versus time function and determining the morphology parameters of the distance versus time function when an event is detected. The method also includes the procedure of classifying the event according to the determined morphology parameters of the distance versus time function.

In accordance with another aspect of the disclosed technique, there is thus provided a system for detecting and classifying an event. The system includes a database and an event detector a classifier. The database is coupled with the event detector and classifier. The database stores a plurality of data instance. Each data instance includes values associated with a measured at least one selected attribute, the values defining the location of a point corresponding to each data instance in an attribute space. At least some of the dimensions of the attribute space are each associated with respective one of the at least one selected attribute. Each of the data instances is further associated with a time-stamp. The event detector and classifier determines the distance in the attributes space, between each point corresponding to a selected data instance and a K^{th} preceding point. The event detector and classifier determines a distance versus time function from the determined distances and the time-stamps associated with each of the selected instance. The event detector and classifier detects the occurrence of an event according to a distance threshold of the distances in the distance versus time function and determines the morphology parameters of the distance versus time graph when an event is detected. The event detector and classifier classifies the event according to the determined morphology parameters of the distance versus time graph.

### BRIEF DESCRIPTION OF THE DRAWINGS

The disclosed technique will be understood and appreciated more fully from the following detailed description taken in conjunction with the drawings in which:

FIG. 1 is a schematic illustration of an event detection and management system, constructed and operative in accordance with an embodiment of the disclosed technique;

FIG. 2 is a schematic illustration of an exemplary attributes space, depicting the graphing of data instances resulting from consecutive measurements of selected attributes in attributes space, in accordance with another embodiment of the disclosed technique;

FIG. 3 is a schematic illustration of distance versus time function, which plots values of d(K) versus time, where k is the number of steps backwards for which d is calculated, in accordance with a further embodiment of the disclosed technique;

FIGS. 4A, 4B, 4C, 4D, 4E and 4F are schematic illustrations of various examples of distance versus time functions, plotting the values of d(K) versus time for various respective events, in accordance with another embodiment of the disclosed technique;

FIG. 5 is a schematic illustration of an exemplary decision tree, generally referenced 250, employed during classifications of the events, in accordance with a further embodiment of the disclosed technique;

FIG. 6 is a schematic illustration of a graph, which depicts the transition between the states of a detection system in accordance with another embodiment of the disclosed technique;

FIG. 7 is a schematic illustration of a method for detecting and classifying event during the testing and monitoring phases, operative in accordance with a further embodiment of the disclosed technique; and

FIG. 8 which is a schematic illustration of a method for determining classification parameters during the learning phase operative in accordance with another embodiment of the disclosed technique.

### DETAILED DESCRIPTION OF THE EMBODIMENTS

The disclosed technique overcomes the disadvantages of the prior art by providing a method for detecting and classifying events in an industrial system (e.g., a water supply system) using two key elements, the first by classifying the RW pattern and the Second by imposing superposition of the RW pattern over the density map.

An abnormal occurrence may occur in a variety of applications and systems. In each such application and systems, respective physical attributes are acquired or measured. For example, in a water supply system or a sewage system the physical attributes may be salinity, acidity (pondus Hydrogenii—pH), temperature, conductivity, Total Organic Carbon (TOC), residual chlorine, alkalinity, nitrate (NO₃), Oxidation Reduction Potential (ORP), turbidity, UV optical density at 254 nm (UV254), hardness, pressure, flow rate and the like. In an electrical supply system the physical attributes may be electric current, voltage, phase, frequency, location in the network and the like. In such systems, the physical attributes are acquired by measurements from a sensor or a group of sensors. Also, an abnormal occurrence may be detected in a population of humans. In human population the physical attributes are, for example, date of birth, place of birth, gender, height, weight, hair color, build, illnesses and the like. As a further example, an abnormal occurrence may be detected in computer systems and networks, for detecting abnormal e-mail traffic in an organization (e.g., a company, a government office and the like). When detecting abnormal e-mail traffic the acquired attributes may be the time and date of each e-mail was sent, the size in kilobytes of each e-mail, the IP and MAC addresses of the sender and recipients of each e-mail, if the e-mail included attachments and the like. Additional examples may include detecting abnormal occurrences in monitored air traffic, sea traffic and road traffic.

Herein below, the disclosed technique is explained using the supply system example. In the description herein below, an occurrence is also referred to as an ‘event’ and an abnormal occurrence is also referred to herein below as an ‘abnormal event’. Furthermore, the data instances in supply systems are produced by data measurements of the attributes of the supply systems. These data measurements of the attributes may be real-time data measurements or the pre-acquired data measurements (i.e., data measurements that are stored in a database). It is noted that the terms ‘measurement’ and ‘data measurement’ are used herein interchangeably and relate to the measurements of the attributes acquired by the sensor units. The term ‘record’ and ‘data record’ herein are also used interchangeably and relate to the stored entries of the measurements in a database. The term ‘data instance’ relates herein to data produced by the sensor units (i.e., the attributes measurements) which may be stored in a database or processed directly or both. The term ‘point’ or ‘data point’ are also used herein interchangeably and related to the location of a data instance in an attribute space. Thus, each data instance record, and point is associated with a corresponding attributes measurements. It is noted that the disclosed technique described below relates similarly to both data measurements and stored data records (i.e., to data instances).

According to the disclosed technique, an event detection and management system includes a plurality of sensor units, which continuously measure the various attributes and produce data instances. The sensor units provide the data instances in real-time to either an event detector and classifier or a database or both. Alternatively, the sensor units measure the attributes periodically (e.g., once every minute, once every hour) and the instances between the measurements are determined according to a statistical model or any other data transformation based on prior instances determined from the measurement of the sensor units.

The event detector and classifier classifies the data instances or sequences of attributes instances as either corresponding to a normal event or events or to an abnormal event or events. To that end, the event detector and classifier determines the coordinates of each of the normalized data points in an attribute space (i.e., projects the attributes data instance onto the attribute space). The event detection and management system employs the distances of the data points from respective selected adjacent points in order to detect events. It is noted that the time-stamp is not an attribute of the supply system and accordingly the attribute space does not include a time dimension. The event detector and classifier determines for each selected data point, at least the distance (i.e., in the attribute space) between the selected point and a respective selected adjacent point (i.e., either preceding or succeeding measurement). The distance can be measured in normalized Euclidian units or according to another distance metric (e.g., Manhattan distance). Furthermore, the event detector and classifier determine clusters of the points in the attribute space and assign a respective identification (ID) for each cluster.

In the steady state (i.e., when no events are occurring), the change in the distance between the data points and the respective selected adjacent data points, over time, corresponds to a random walk (RW) motion pattern. In the examples detailed herein below, the adjacent data point is a preceding point, acquired prior to the selected attributes measurement. The distance between a data point T_{N} and a respective preceding data point T_{N-K} (i.e., the distance D(T_{N}−T_{N-K})) is considered as one step of the RW motion pattern. The distance D(T_{N+1}−T_{N-K+1}) is considered as a consecutive step of the RW motion pattern, and so forth. As further elaborated below, the event detector and classifier determines a function of the distances between selected data points and a respective preceding (or subsequent) K^{th} data point (i.e., also referred to herein as ‘K^{th} adjacent measurement’) versus the time-stamp value of the selected data point. The event detector and classifier analyses the morphology of this function to classify an event also as further explained below. The manner in which ‘K’ is determined is further explained below.

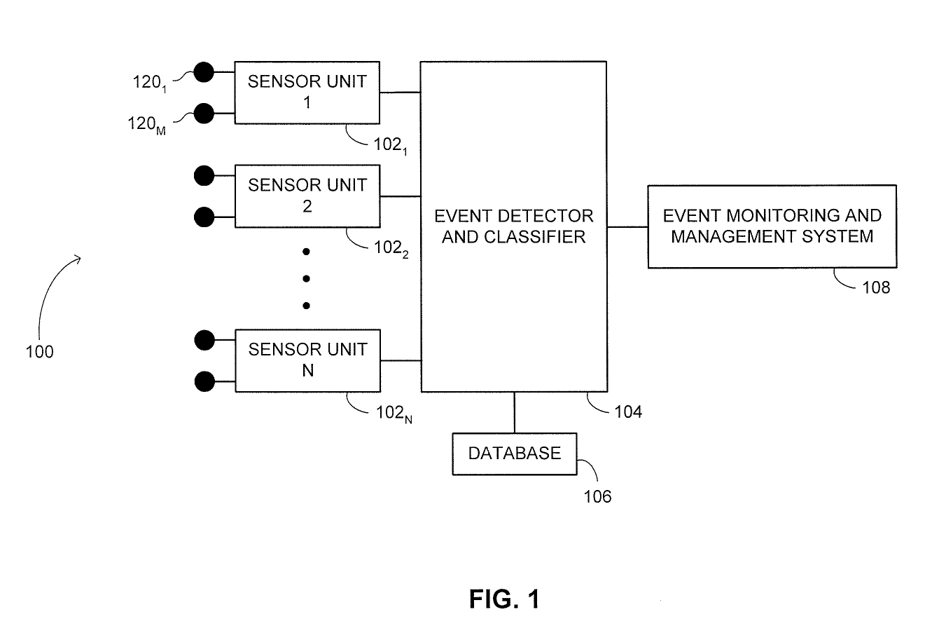

Reference is now made to FIG. 1, which is a schematic illustration of an event detection and management system, generally referenced 100, constructed and operative in accordance with an embodiment of the disclosed technique. System 100 includes a plurality of sensor units 102₁, 102₂, . . . , 102_{N}, an event detector and classifier 104, a database 106, an event monitoring and management system 108. Each one of sensor units 102₁, 102₂, . . . , 102_{N}, includes a plurality of respective sensors such as sensors 120₁, . . . , 120_{M}.

Each one of sensor units 102₁, 102₂, . . . , 102_{N}, acquires a plurality of data measurements of the various attributes from the respective sensors thereof and produces data instances. Sensor units 102₁, 102₂, . . . , 102_{N} provide the data instances produced thereby to either event detector and classifier 104 for processing, or to database 106 for storing and processing at a later time. When a data instance is associated with a time-stamp, the data instance may be expressed in vector form as follows:

\vec{X}^{t(m)}=(x₁^{t(m)},x₂^{t(m)}, . . . , x_{N}^{t(m)}) (1)

where \vec{X}^{t(m)} represents a data instance, x₁, x₂, . . . ,x_{N} represent the different attributes of the instance and the superscript t(m) indicates the time at which the measurements were acquired. Each one of sensor units 102₁, 102₂, . . . , 102_{N} provides the data instance produced thereby (i.e., the data measured thereby) to event detector and classifier 104.

Since each attribute may be measured on a different scale (e.g., temperature is measured in degrees while salinity may be measured in milligrams per liter), event detector and classifier 104 optionally normalizes (i.e., brings to a common scale) the attributes of the data measurements. For example, event detector and classifier 104 may normalize the attributes by standard deviation or by variable range.

Normalizing by standard deviation is performed by subtracting from each attribute value the respective attribute average (i.e., the average of all the values of all the measurements of the same attribute), and dividing this difference by the standard deviation of the attribute values. This can be expressed mathematically as follows:

$${\vec{𝒳}}^{t ( m )} = ( \frac{{x}_{1}^{t ( m )} - {μ}_{1}}{{σ}_{1}} , \frac{{x}_{2}^{t ( m )} - {μ}_{2}}{{σ}_{2}} , … , \frac{{x}_{N}^{t ( m )} - {μ}_{N}}{{σ}_{N}} ) \qquad ( 2 )$$

where μᵢ and σᵢ are the mean and standard deviation of the i^{th} attribute measurement respectively and xᵢ^{t(m)} is the measurement of the i^{th} attribute at time t(m).

Normalization by variable range is performed by dividing the difference between the value of the attribute and the lowest attribute value by the difference between the highest attribute values and the lowest attribute value. This may be expressed mathematically as follows:

$${\vec{𝒳}}^{t ( m )} = ( \frac{{x}_{1}^{t ( m )} - {x}_{1 , min}}{{x}_{1 , max} - {x}_{1 , min}} , \frac{{x}_{2}^{t ( m )} - {x}_{2 , min}}{{x}_{2 , max} - {x}_{2 , min}} , … , \frac{{x}_{N}^{t ( m )} - {x}_{N , min}}{{x}_{N , max} - {x}_{N , min}} ) \qquad ( 3 )$$

where x_{i,min},x_{i,max} are the minimum and maximum measurement values of the i^{th} attribute respectively and xᵢ^{t(m)} is the measurement value of the i^{th} attribute at time t(m).

Employing the normalization expression described in Equation (3) may require outlier filtering (i.e., removing “spikes” in the data measurements), for example by using a median filter. Thus, the minimum and maximum values are maintained within a nominal range. Normalizing by standard deviation is preferred in the case of a normally distributed variable and normalizing by variable ranges is preferred in the case of outlier measurements (e.g., from a skewed distribution).

As mentioned above, the event detector and classifier 104 determines the coordinates of each of the normalized attributes data instance in an attribute space (i.e., projects the attributes measurements onto the attribute space). The event detection and management system relates the distances of selected points in the attribute space from respective adjacent points in order to detect events.

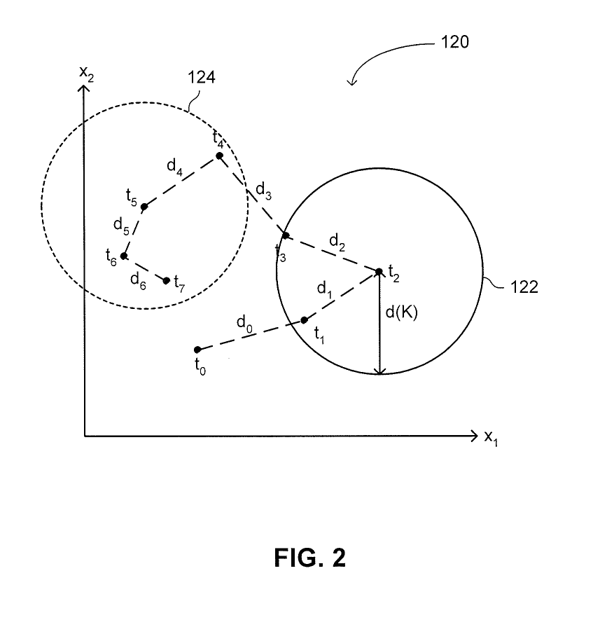

Reference is now made to FIG. 2, which is a schematic illustration of an exemplary attributes space, generally referenced 120, depicting the graphing of data instances resulting from consecutive measurements of selected attributes in attributes space 120, in accordance with another embodiment of the disclosed technique. Each point in the attribute space corresponds to a respective data instance and thus with respective attributes measurement values. Attribute space 120 is optionally a normalized attribute space. Exemplary attribute space 120 includes a two-dimensions, each corresponding to a respective attribute x₁ and x₂. FIG. 2, depicts also the order in which measurements were acquired (i.e., in 2D attribute space 120). The dashed line connects time consecutive attributes measurements and dᵢ denotes the distance between the \vec{x}^{t(i)} attributes measurement and the \vec{x}^{t(i+1)} attributes measurement. In general, as described above, the trajectory of the data records in the attributes space, for a single, non-faulty un-perturbed sensor unit exhibits a RW pattern. The term ‘un-perturbed sensor unit relates to a sensor unit with respective sensor which were not influenced by changes to quantity measured by the sensors (e.g., current, voltage, conductivity, temperature, acidity, turbidity and the like) either due to operational changes in the system being monitored (e.g., change of water source or change of electricity source) or due to abnormal events effecting the measured quantities.

In general, distance may be a Euclidian distance metric generally given by:

dᵢ=(Σⱼ₌₁^{N}(\vec{x}ⱼ^{t(i)}−\vec{x}ⱼ^{t(i+1)})²)^{0.5} (4)

where the j sub-script indicates the attribute.

The distance metric may alternatively be a curved space metric (with close distance approximation) generally given by:

dᵢ=(Σⱼ₌₁^{N}g(α·(\vec{x}ⱼ^{t(i)})+(1−α)·(\vec{x}ⱼ^{t(i+1)}))(\vec{x}ⱼ^{t(i)}−\vec{x}ⱼ^{t(i+1)})²)^{0.5} (5)

where g: [symbol] ^{N}→ [symbol] is a metric function, which weights distances differently over different regions of the normalized attribute space. The metric g, is problem specific and may be fine-tuned for each problem specifically. In general, g equals 1 by default.

As mentioned above, the adjacent data measurement is a preceding attributes measurement, acquired prior to the selected attributes measurement. The distance between a selected data point T_{N} and a respective preceding data point T_{N-K} (i.e., the distance D(T_{N}−T_{N-K})) is considered as one step of the RW motion pattern. The distance D(T_{N+1}−T_{N-K+1}) is considered as a consecutive step of the RW motion pattern, and so forth. Herein, the distance between a selected data point (i.e., with respective attributes measurement and time-stamp) T_{N} and a respective preceding data point T_{N-K} is denoted ‘d(K)’. The event detector and classifier 104 (FIG. 1) determines a function of the distance between a selected point and a respective preceding K^{th} point (i.e., also referred to herein as ‘K^{th} adjacent point’) versus the time-stamp value of the selected points. The event detector and classifier 104 analyses this function and determines morphology parameters of the distance versus time function. Event detector and classifier 104 classifies an event according to these morphology parameters as further exemplified below. It is noted that not all the attributes need to be employed for detecting and classifying events. Rather, selected attributes may be employed for detecting and classifying different events. For example, in a water supply system, pH and Conductivity may be employed to detect non-organic contamination while TSS, Turbidity and free chlorine may be employed for detection of organic contamination. The distance versus time function is determined according to the distances in the attribute space which includes dimensions corresponding only to the selected attributes.

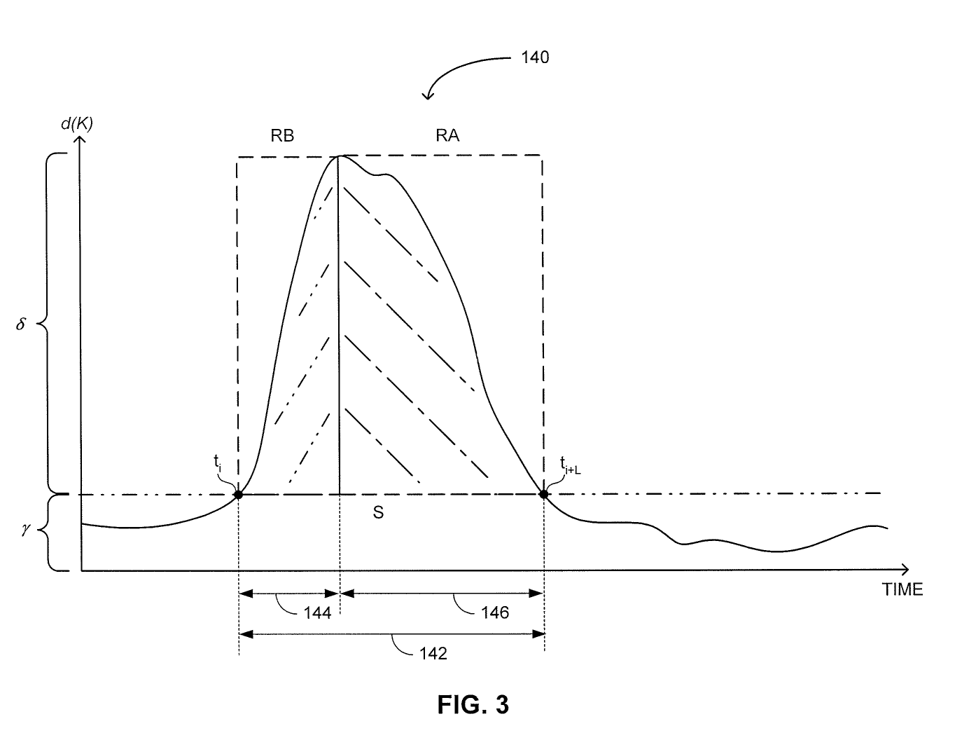

Reference is now made to FIG. 3, which is a schematic illustration of distance versus time function, generally referenced 140, which plots values of d(K) versus time, where k is the number of steps backwards for which d is calculated, in accordance with a further embodiment of the disclosed technique and still referring to FIG. 1. For example, with reference to FIG. 2, when K=3, d(K) is measured between points t₇ and t₄, t₆ and t₃, t₅ and t₂ etc. When the system is in steady state, only small changes occur in the values of the attributes measurements. Thus, the value of d(K) is small due to the fact that that the RW distance is small. The range of d(K) during steady state operation of the system can be learned or determined as further explained below. In FIG. 3, that range is denoted as ‘γ’. Thus, γ may be considered a threshold above which an event is suspected to occur. Specifically, this value represents the maximum distance that the RW may produce for K steps with confidence interval of α where 0<α<1.

An event in may be characterized by the following morphology parameter of the distance version time function as shown in FIG. 3:
Length to Height ratio;
Peak Ratio;
Symmetry Ratio;
Time Before Event;
Neighboring Density;
Event Trajectory.

The Length to Height ratio is defined by the ratio between time period 142, in which the value of d(K) is above the threshold value γ, to the value of the peak of d(K) and denoted by γ+δ. Time period 142 is also denoted ‘S’ in FIG. 3. This ratio will be referred to herein as LH (Length Height) ratio.

The Peak Ratio relates to the ratio between the peak value of d(K) during the event and the threshold value, γ. This ratio will be referred to herein as PR (Peak Ratio). This ratio may be measured by the ratio between γ and the peak value of d(K) above γ (i.e., δ in FIG. 3). Alternatively, this ratio may be measured by the ratio between γ and the absolute peak value of d(K) above (i.e., γ+δ in FIG. 3).

Symmetry Ratio relates to the ration between time-period 144 and time-period 146. Time period 144 refers to time period between the time instance d(K) exceeded the threshold γ and the time instance d(K) reached the peak value thereof. Time period 144 is also referred to as ‘RB’ in FIG. 3. The time period 146 refers to time period between the time instance d(K) reaches the peak value thereof and the time instance d(K) fall beneath the threshold γ. Time period 146 is also referred to as ‘RA’ in FIG. 3. The ratio between RA and RB is the symmetry ratio referred to herein also as SR (Symmetry Ratio).

Time Before Event relates to the amount of time elapsed before last abnormal event in units of time (e.g., seconds, minutes, hours, days). This value should have a maximum value defined by the user. It is based on the maximum time duration historical events should influence each other in the system. This value will be referred to henceforth as NB (Normal before). The time difference between events has a mean and a standard deviation. Thus, the time difference between events may be related to the type of event. For example, if the time difference between a current event and a previous event is above or below the Mean Time Between Events (MTBE) by more than a selected number of standard deviations, then that event may be classified as an abnormal event. If the time difference between a current event an a previous event is either equal or above or below the Mean Time Between Events (MTBE) by less than a selected number of standard deviations, then that event may be classified as a normal event.

Neighboring Density relates to the density of points in the region in the attribute space, of a selected point in the distance versus time function, after an event was detected (i.e., after the function crossed the threshold γ). The region is defined, for example, as a circle around the selected point in the attribute space, which exhibit the radius of d(K). For example, with reference to FIG. 2, data point t₂ is the selected data point and points t₁ and t₃, within circle 122 (i.e., other than t₂) define the neighboring density. The region may also be defined as a square or a hexagon around the selected point. The density is measured relative to the region around the data point with the highest number of data points therein (i.e., neighboring density exhibits a value between 0 and 1). For example, with reference to FIG. 2, neighboring density is measured relative to the number of points within hatch circle 124 around point t₅. Thus, the neighboring density of point t₂ is ⅔. Neighboring density will also be referred to herein as ND (Neighboring Density). A high neighboring density may indicate that the event is a normal event since measurements were acquired within that region. Conversely, a low neighboring density may indicate that the event is an abnormal event.

The Event Trajectory relates to the source cluster and the destination cluster of the event. The source cluster is the cluster, in the attribute space, to which the first data point of the event, tᵢ (FIG. 3), belongs (i.e., the first data point after the distance versus time function exceeded the threshold γ). The destination cluster is the cluster in the attribute space to which the last data point of the event, t_{i+L} (FIG. 3), belongs (i.e., the last data point before the distance versus time function decreases back below the threshold γ). A destination cluster identical to the source cluster may indicate an abnormal event. Conversely, a destination cluster different from the source cluster may indicate and a normal event. This parameter will be referred to henceforth as ET (Event Trajectory). Note that ET is one out of all possible trajectories between clusters where each transition gets an ordered number.

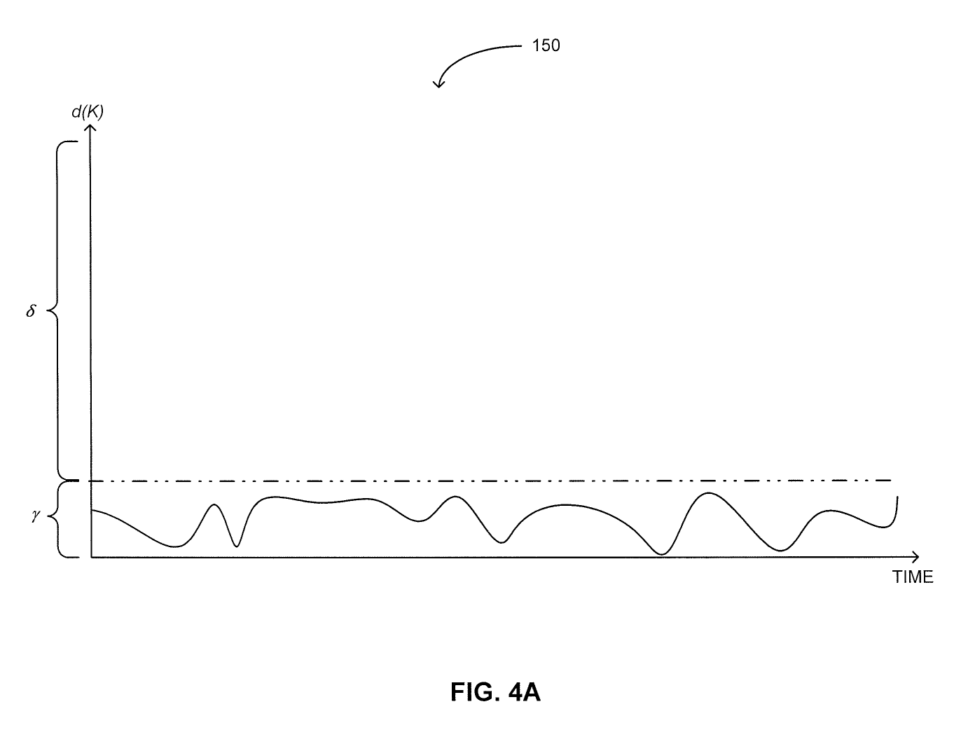

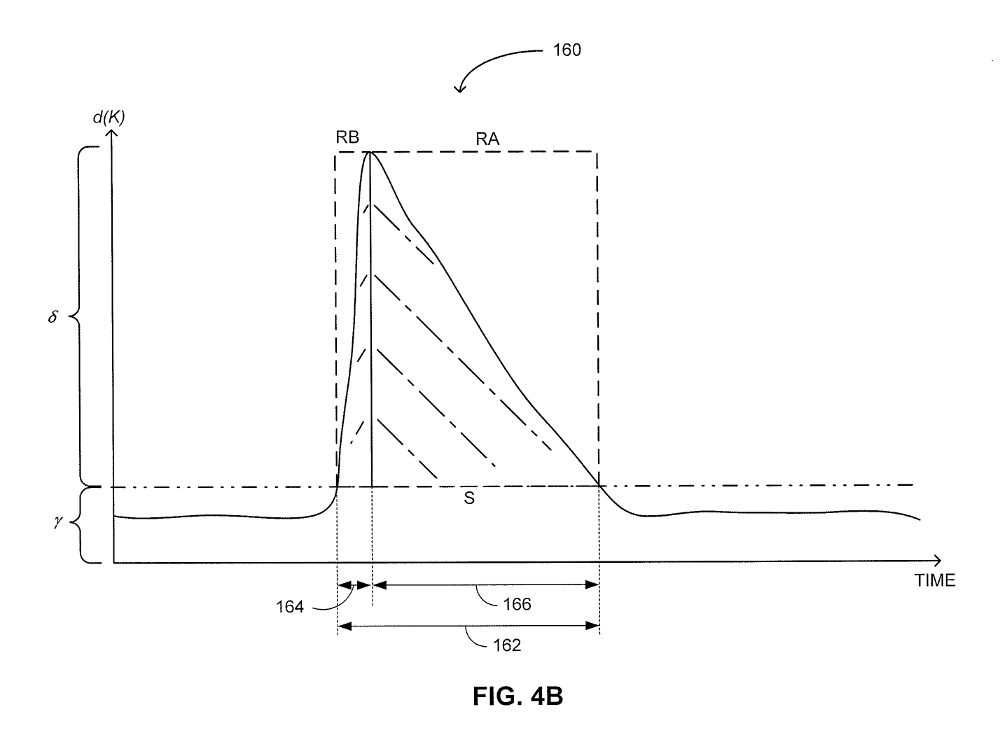

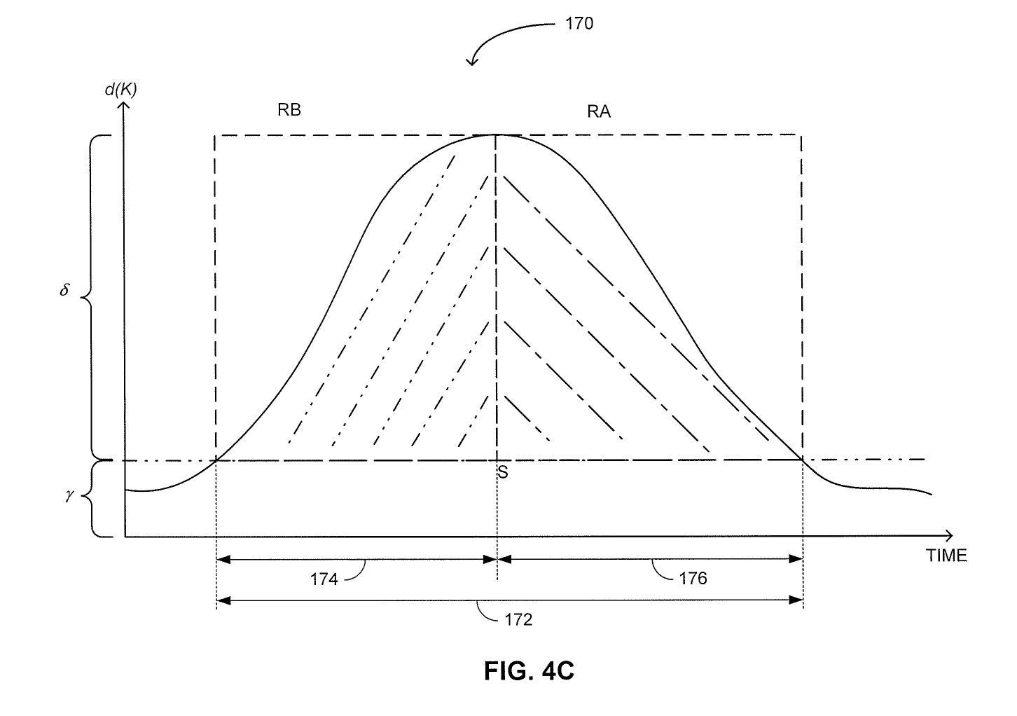

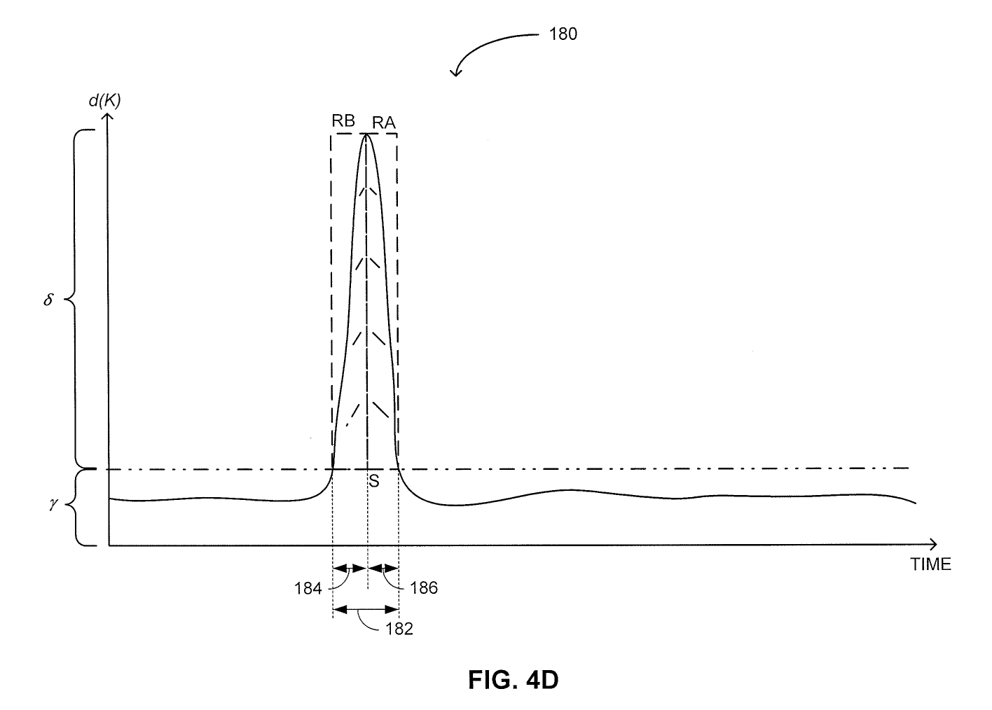

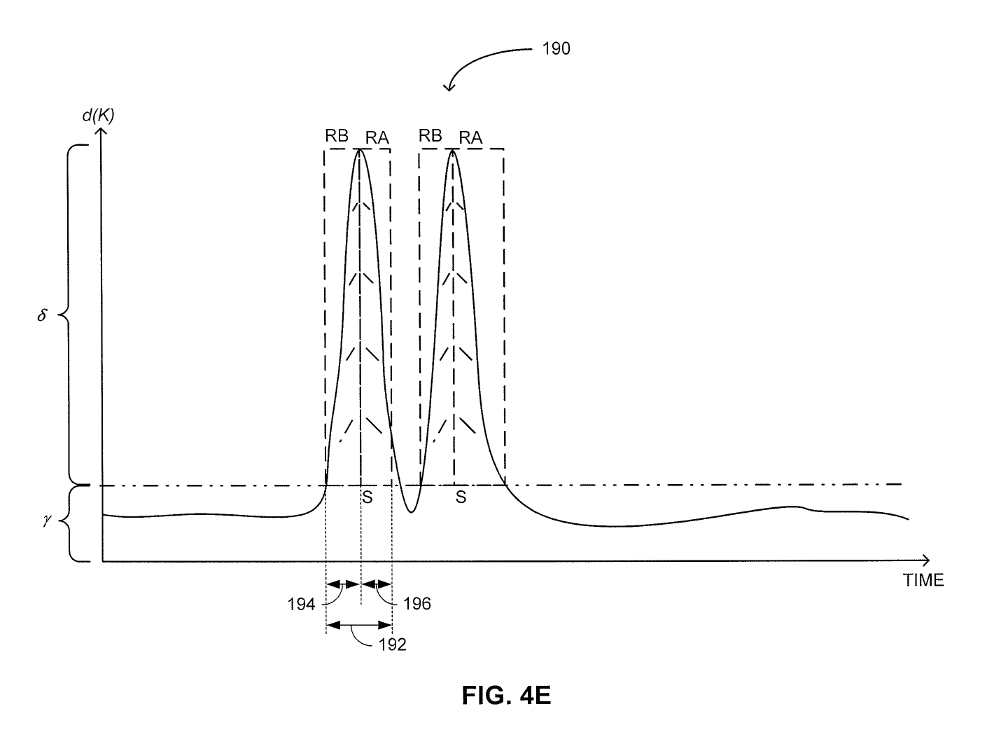

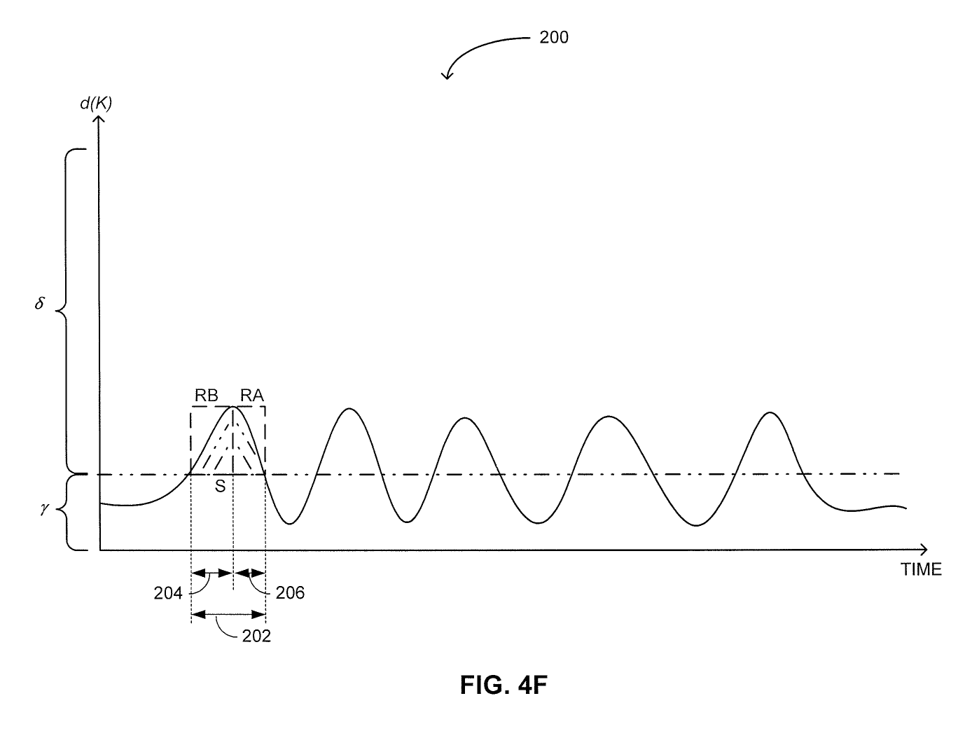

An event detection system according to the disclosed technique employs at least one, a portion or all of the above six morphology parameters to classify an event. Reference is now made to FIGS. 4A, 4B, 4C, 4D, 4E and 4F which are schematic illustrations of various examples of distance versus time functions, generally referenced 150, 160, 170, 180, 190, and 200 respectively, plotting the values of d(K) versus time for various respective events, in accordance with another embodiment of the disclosed technique. These examples shall be explained with regards to a water supply system and apply also to sewage systems.

With reference to FIG. 4A, graph 150 depicts the values of d(K) versus time for a normally functioning (i.e., not faulty) and un-perturbed sensor. As depicted in function 150, the values of d(K) do not exceed the threshold γ. As such, no event is detected nor classified by event detection and classified 104 (FIG. 1).

With reference to FIG. 4B, distance versus time function 160 depicts the values of d(K) versus time of a sudden contamination introduced into the water supply system, which is then gradually diluted. In such an event, the symmetry ratio, SR, is relatively small. Function 160 is typical to sensor units which are located in close proximity to the source of contamination.

With reference to FIG. 4C, distance versus time function 170 depicts the values of d(K) versus time of a gradual contamination introduced into the water supply system, which is then diluted. In such an event the Length to Height ration LH is relatively large since the time duration of the event may be long. Furthermore, in FIG. 4C, RB and RA are substantially equal which entails that SR is approximately equal to one. A function such as distance versus time function 170 is typical to sensor units which are located far from the contamination source. It is noted that by employing at least two distance versus time functions such as distance versus time function 160 and distance versus time function 170, related to respective two sensor units located on a contaminated supply line, at least an indication of the location of the contamination source may be obtained by ordering the functions, for example, according their respective LH and inspecting the location of the sensor units. It is further contemplated that the diffusion equation, described below in equation (6), may be solved to determine the exact location of the source of contamination.

With reference to FIG. 4D, distance versus time function 180 depicts the values of d(K) versus time of a change of the water source supplying the water to the water supply system. In Such an event, the LH is substantially small and SR is approximately 1.

With reference to FIG. 4E, distance versus time function 190 depicts the values of d(K) versus time of a faulty sensor. Such an event exhibits two similar peaks. However, NB is below the Mean Time Between Events (MTBE) by more than a selected number of standard deviations and as such, these two peaks are considered to be related and are indicative of a faulty sensor (i.e., an abnormal event).

With reference to FIG. 4F, distance versus time function 200 depicts the values of d(K) versus time of a ‘crawling sensor’. In such an event (i.e., a crawling sensor event), the sensor is not necessarily faulty but the measurements thereof are perturbed. Such an event also exhibits NB below the Mean Time Between Events (MTBE) by more than a selected number of standard deviations. Furthermore, the LH associated with such an event is substantially large and the SR associated with such an event is approximately 1.

Following is a classification example in which an event is classified to be frequent or non-frequent and as either hazardous, non-hazardous or unknown (i.e., two-dimensional classification). Thus, an event can be classified to be one of six possible classes, Frequent-Non-Hazardous, Frequent-Hazardous, Frequent-Unknown, Infrequent-Non-Hazardous, Infrequent-Hazardous and Infrequent-Unknown. Such a classification may be summarized in the form of a table such as Table 1. In Table 1, the vertical axis refers to frequency (i.e. the event is frequent or non-frequent) and the horizontal axis refers to event type (i.e. Non-Hazardous, Hazardous or Unknown).

TABLE 1

| | Hazardous | Non-Hazardous | Unknown |
|---|---|---|---|
| Non-frequent | | | |
| Frequent | | | |

A table such as Table 1 is referred to as an Events Characteristics Table (ECT). A classification algorithm such as decision tree may be employed to map events to the ECT.

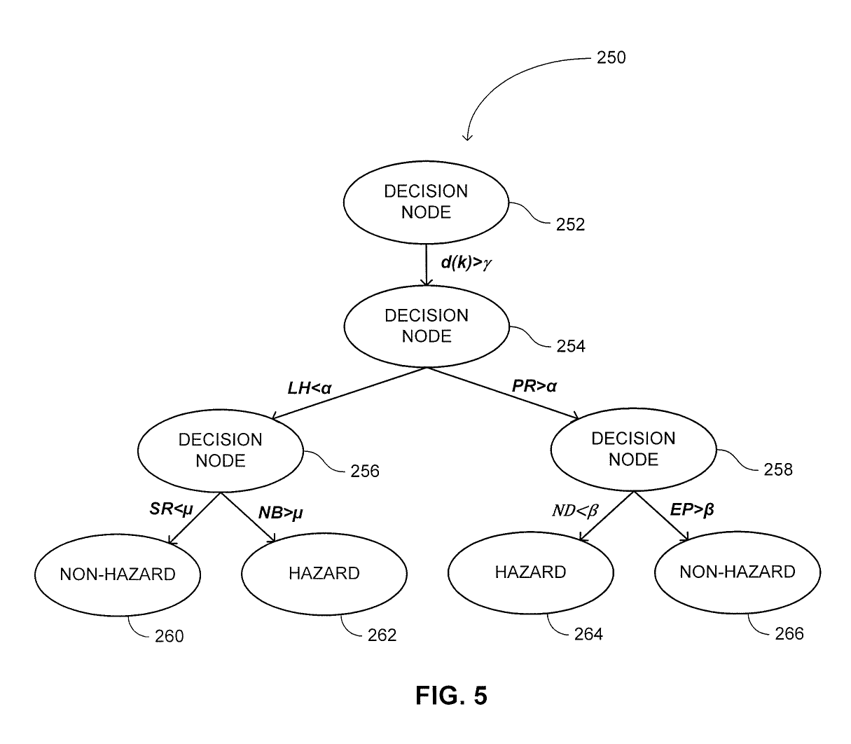

Reference is now made to FIG. 5, which is a schematic illustration of an exemplary decision tree, generally referenced 250, employed during classifications of the events, for example, in an ECT, in accordance with a further embodiment of the disclosed technique and referring to FIG. 1. Decision tree 250 is brought herein as an example only. More complex trees may be constructed accounting for the various scenarios. Initially, in decision node 252 (i.e., the source node), event detector and classifier 104 calculates the value d(K). When the value of d(K) exceeds the threshold γ, then event detector and classifier 104 determines that an event is occurring or has occurred. In decision node 254, event detector and classifier 104 determines the values of LH (i.e., the length to height ratio) and PR (i.e., the peak ratio). When LH is smaller than a value of α, then, event detector and classifier 104 proceeds to decision node 256. When PR larger than α, then event detector and classifier 104 proceeds to decision node 258. In decision node 256, event detector and classifier determines the values of SR (i.e., the symmetry ratio) and NB (i.e., time before event). When SR is smaller than a value of μ, then event detector and classifier 104 determines that the event is not a hazardous event. When NB is larger than μ, then event detector and classifier 104 determines that the event is a hazardous event.

In decision node 258, event detector and classifier 104 determines the values of ND (i.e., the neighborhood density) and EP (i.e., the event trajectory). When ND is smaller than a value of β, then event detector and classifier 104 determines that the event is a hazardous event. When EP larger than β, then event detector and classifier 104 determines that the event is not a hazardous event.

In general, event classification may include three phase, the training phase the testing phase and the monitoring phase. During the learning phase data related to known events is collected for each time-stamp t and stored in the system database. The event detection system, such as system 100 (FIG. 1) learns the values, ranges and weights of the morphology attributes (i.e., γ, LH, PR, SR, NB, ND and EP) of various distance versus time functions (e.g., distance versus time function 150—FIG. 3) corresponding to different events (e.g., sensor failure, sudden contamination, change of supply source, hazardous, non-hazardous and the like), which are classified with the aid of an expert. During the learning phase the event detection and classification system does not generate alerts.

During the testing phase, the detection system employs the information acquired during the learning phase in order to detect and classify data records, relating to known and classified events (e.g., determined by an expert), which have not been employed during the learning phase. The result of the classification provided by the event detection and classification system may also be analyzed by an expert to validate the correctness thereof. The result of the testing phase is a score describing the ability of the detection system to detect and classify events. The records in the testing set are tagged by an expert as normal or abnormal. Furthermore, the expert may classify the event (e.g., faulty sensor, change of supply source). These tags and classifications are labeled as the actual classification.

For each record, the event detection and classification system determines a distance versus time function, ‘d(K)’. Once the value of d(K) is above the threshold γ, the event detection and classification system determines the values of the morphology parameters LH, PR, SR, NB, ND, EP for that event and the event detection and classification system classifies the event accordingly. This classification is regarded as the predicted classification. Then, a correspondence between the events classified by the system and the events classified by the expert is searched (i.e., either by the expert of by the system). Using the actual classification and the predicted classification, a Model Classification Quality table, from which a score can be derived (e.g., the number of correct classifications versus the total number of events). Table 2 illustrates an example of a Model Classification Quality table, where events are classified as either hazardous or non-hazardous. The predicted classification is further classified as being either True-Negative, True-Positive, False-Positive or False-Negative.

TABLE 2
Model Classification Quality

| Classification | Predicted | Actual |
|---|---|---|
| True-Negative (TN) | Non-Hazard | Non-Hazard |
| True-Positive (TP) | Hazard | Hazard |
| False-Negative (FN) | Non-Hazard | Hazard |
| False-Positive (FP) | Hazard | Non-Hazard |

The count and weight of each group (i.e., TN, TP, FN or FP) is used in order to generate an index for the model classification quality. This index can be used for comparing between different models or between different setup parameters of the same model, for example, between a model with different number of variables or the same model with different values of k or γ. Also, the system enables a user to approve or dis-approve events which has been classified by the system. The system relates the counts of approved and disapproved events to the corresponding entry in the ECT. Thus, each entry at the ECT table gain creditability (i.e., over time) based on the amount of approved and disapproved events related thereto.

During monitoring phase, the event detection and classification system classifies data instances according to that which has been learned and validated in the learning and testing phases. During this phase if an event (i.e., which is a group of related records or measurements) meets a determined criteria, an alarm may be generated.

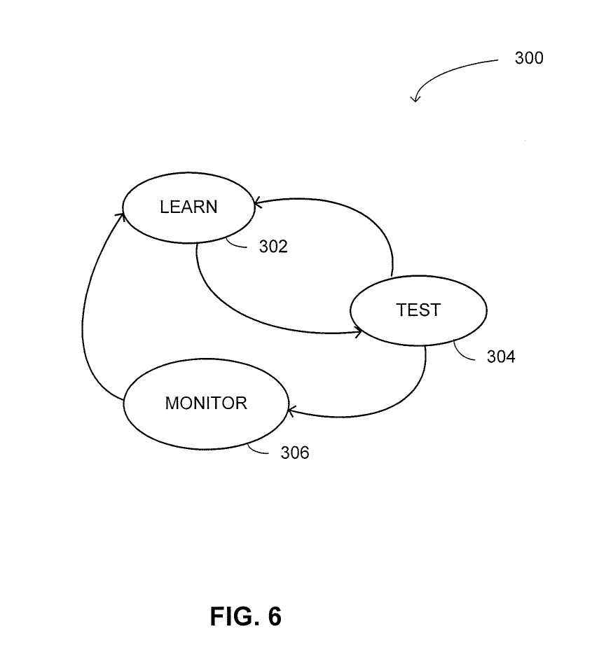

Reference is now made to FIG. 6, which is a schematic illustration of a graph, generally referenced 300, which depicts the transition between the states of a detection system in accordance with another embodiment of the disclosed technique. As mentioned above, these states include learning state 302, the testing state 304 and the monitoring state 306. As depicted in FIG. 6, after learning phase 302 the system moves to testing phase 304. When the results obtained during testing phase 304 are satisfactory, the system moves to monitoring phase 306. When the results obtained during testing phase 304 are not satisfactory, the system may return to the learning phase 302. After testing phase 304 the system moves to monitoring phase 306. The system may further move from monitoring phase 306 back to learning phase 302 when conditions apply (e.g., either periodically or when the number of false alarms exceed a predetermined value or when the frequency of false alarms exceed a predetermined value).

As mentioned above, the threshold γ may be determined with the aid of an expert. Also as mentioned above, the trajectory of the data points in the attributes space, for a single sensor unit and for d(K), exhibits a RW motion pattern. Accordingly, if ρ(x,t) denotes the density of data points at location x (i.e., in the attribute space) at time t, then ρ(x,t) satisfies the diffusion equation as follows:

$$\frac{\partial ρ}{\partial t} = D \frac{{\partial }^{2} ρ}{\partial {x}^{2}} \qquad ( 6 )$$

where D is the mass diffusivity (i.e., how fast data points may move in the attribute space). The solution of equation (6), gives a density function with second moment given by:

x̅²̅=2D*t (7)

Equation (7) expresses the distance a data point can be found from the origin given the time elapsed and the diffusivity. Assuming x is distributed normally, the maximum value a particle (i.e., a normalized point in a multi dimension attributes space) can travel for a given time can be calculated using (7) with a given confidence interval.

As such, the maximum distance a particle can travel γ, with a confidence interval of h is given by

γ=2D*t*s(h) (8)

where h is given in confidence percentage and s(h) is the student distribution. Thus, the above mentioned threshold γ may also be analytically determined.

Alternatively, to determine the threshold γ, during the learning phase, event detection and characterization system 100 determines a distribution function of the distances of the instances (i.e., in the attribute space) from the point of origin, after a predetermined period of time (e.g., which corresponds to the Mean Time Between Events). Event detection and characterization system 100 selects the distance with the highest probability as the threshold γ.

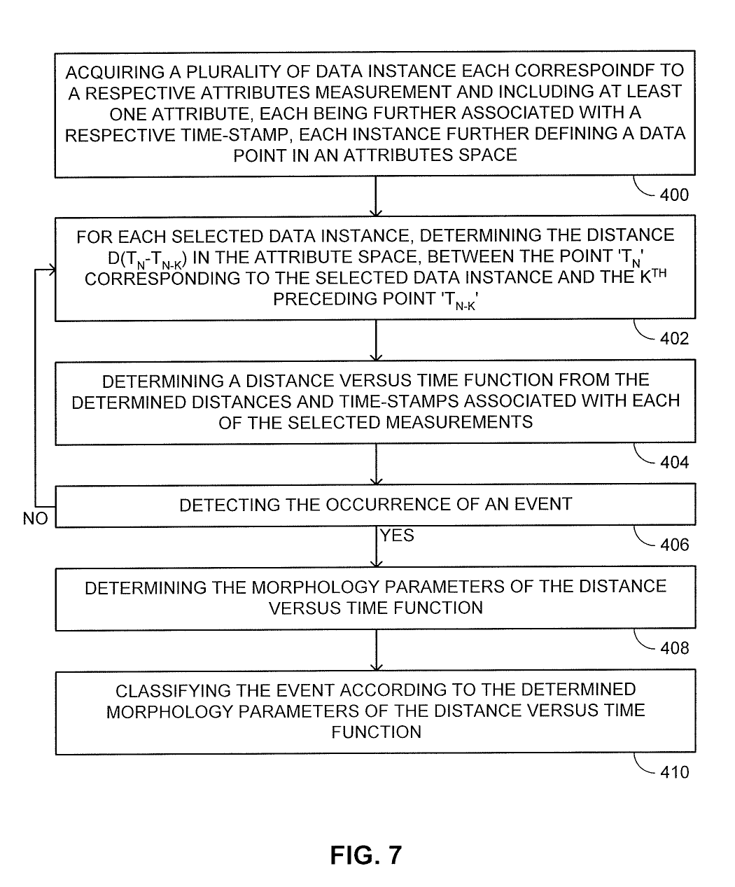

Reference is now made to FIG. 7, which is a schematic illustration of a method for detecting and classifying event during the testing and monitoring phases, operative in accordance with a further embodiment of the disclosed technique. In procedure 400, a plurality of data instances are acquired. Each data instance corresponds to a respective attributes measurement, includes at least one attribute and is associated with a respective time-stamp and further defines a data point in an attributes space. With reference to FIG. 1, each one of sensor units 102₁, 102₂, . . . , 102_{N} acquires a plurality of data measurements from the respective sensors thereof. Additionally, each of the data measurements is associated with a respective time-stamp. Sensor units 102₁, 102₂, . . . , 102_{N} produce data instances and provide the data instance to event detector and classifier 104 for processing or to database 106 for storage.

In procedure 402, for each selected instance, the distance D(T_{N}−T_{N-K}) in the attributes space, between the point ‘T_{N}’ corresponding to the selected instance and the K^{th} preceding point ‘T_{N-K}’ is determined. With reference to FIG. 1, for each selected data instance, event detector and classifier 104 determines the distance between the point ‘T_{N}’ and the K^{th} preceding point ‘T_{N-K}’. For example, with reference to FIG. 2, when K=3, d(K) is measured between points t₇ and t₄, t₆ and t₃, t₅ and t₂ etc.

In procedure 404, a distance versus time function is determined from the determined distances D(T_{N}-T_{N-K}) and the time-stamps associated with each of the selected measurements. With reference to FIGS. 1 and 3, event detector and classifier determines a distance versus time function such as distance versus time function 150, from the determined distances and the time-stamps associated with each measurement.

In procedure 406, the occurrence of an event is detected. An event is detected when a distance D(T_{N}−T_{N-K}) in the distance versus time function exceeds threshold γ. With reference to FIG. 1, Event detector and classifier 104 detects the occurrence of an event when a distance D(T_{N}−T_{N-K}) in the distance versus time function exceeds threshold γ. When an event is detected, the method proceeds to procedure 408. When an event is not detected, the method returns to procedure 402.

In procedure 408, the morphology parameters of distance versus time function are determined. These morphology parameters include at least one of the above mentioned Length to Height ratio, Peak Ratio, Symmetry Ratio, Time before event, Neighboring Density and Event Trajectory. With reference to FIG. 1, event detector and classifier 104 determines the morphology parameters of the distance versus time function.

In procedure 410 the event is classified according to the determined morphology parameters of the distance versus time function. For example, as described above, the vents may be a faulty sensor, a sudden contamination, a change of supply source, a gradually spreading contamination, a crawling sensor. The events may further be classified as a hazardous or non-hazardous event. With reference to FIG. 1, event detector and classifier 104 classifies the event according to the determined morphology parameters of the distance versus time function.

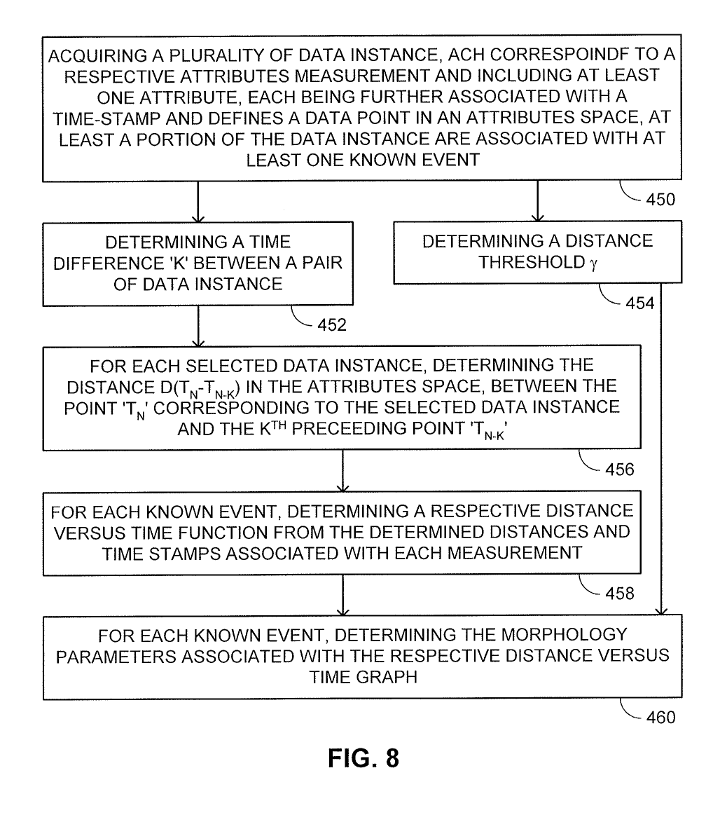

Reference is now made to FIG. 8 which is a schematic illustration of a method for determining classification parameters (i.e., threshold and morphology parameters) during the learning phase operative in accordance with another embodiment of the disclosed technique. In procedure 450 a plurality of data instances are acquired. Each instance corresponds to a respective attributes measurement, includes at least one attribute and is further associated with a respective time-stamp, and further defines a data point in an attribute space. At least a portion of the data measurements are associated with at least one known event. The known event is indicated and classified by an expert. With reference to FIG. 1, each one of sensor units 102₁, 102₂, . . . , 102_{N} acquires a plurality of data measurements from the respective sensors thereof. Additionally, each of the data measurements is associated with a respective time-stamp. Sensor units 102₁, 102₂, . . . , 102_{N} produce data instances provide the data instances to event detector and classifier 104 for processing or to database 106 for storage.

In procedure 452, a time difference K between a pair of data instances is determined. K is determined, for example, to correspond to the mean value or median value of the distance between a pair of data points, for example, during the learning phase. Thus, any deviation from the RW motion pattern of the distances between measurements of selected pairs is more discernible as its magnitude relative to the distance is larger. Furthermore, K may be refined based on classification performance during the testing phase. With reference to FIG. 1, event detector and classifier 104 determines a time difference K either manually or automatically. After procedure 452, the method proceeds to procedure 456,

In procedure 454, a threshold, γ, is determined. When a data instance exceeds this threshold, then an event may be identified as occurring. The threshold, γ, may be empirically determined. Alternatively, this threshold may be analytically determined as described above in conjunction with equations (5), (6) and (7). Alternatively, the threshold γ is determined according to a distribution function of the distances of the measurements (i.e., in the attribute space), from the point of origin also as described above. With reference to FIG. 1 event detector and classifier determines a distance threshold γ. After procedure 454, the method proceeds to procedure 460.

In procedure 456, for each selected data instance, the distance D(T_{N}−T_{N-K}) in the attributes space, between the point ‘T_{N}’ corresponding to the selected data instance and the K^{th} preceding point ‘T_{N-K}’ is determined. With reference to FIG. 1, for each data instance, event detector and classifier 104 determines the distance between the point ‘T_{N}’ and the K^{th} preceding point ‘T_{N-K}’. For example, with reference to FIG. 2, when K=3, d(K) is measured between points t₇ and t₄, t₆ and t₃, t₅ and t₂ etc.

In procedure 458, for each known event, a respective distance versus time function is determined from the determined distances and time-stamps associated with each point. With reference to FIG. 1, for each known event, event detector and classifier 104 determines a respective distance versus time function.

In procedure 460 for each known event, the morphology parameters associated with the respective distance versus time function are determined. It is noted that for each known event, the values ranges and weights of the morphology parameters are determined. With regards to the weights of the morphology parameters, for different events, the same morphology parameter may exhibit a different weight. For example, for a faulty sensor event, LH and NB are more significant, and thus assigned a larger weight, than SR. With reference to FIG. 1, for each known event, event detector and classifier 104 determines the morphology parameters associated with the respective distance versus time function.

It will be appreciated by persons skilled in the art that the disclosed technique is not limited to what has been particularly shown and described hereinabove. Rather the scope of the disclosed technique is defined only by the claims, which follow.

1. A method for detecting and classifying an event comprising the procedure of:
acquiring a plurality of data instances, each corresponding to a respective attributes measurement of selected attributes, each including at least one attribute, each being further associated with a respective time-stamp and defining a data point in an attributes space;
for each selected data instance, determining the distance in said attributes space, between a point ‘T_{N}’ corresponding to said selected data instance and the K^{th} preceding data point ‘Tₙ₋ₖ’;
determining a distance versus time function from the determined distances and time-stamps associated with each said selected data instances;
detecting the occurrence of an event according to a distance threshold of the distances in said distance versus time function;
determining the morphology parameters of said distance versus time function when an event is detected; and
classifying said event according to said determined morphology parameters of said distance versus time function.

2. The method according to claim 1, wherein said morphology parameters include at least one of:
Length to height ratio;
Peak Ratio;
Symmetry Ratio;
Time Before Event;
Neighboring Density; and
Event Trajectory.

3. The method according to claim 1, further including the preliminary procedures of:
acquiring a plurality of data instances, each corresponding to a respective attributes measurement of selected attributes, each including at least one attribute, each being further associated with a time-stamp and defining a data point in said attributes space, at least a portion of said data instances being associated with at least one known event;
determining a time difference ‘K’ between a pair of data instance;
determining a distance threshold;
for each selected data instance, determining the distance in said attributes space between the point ‘T_{N}’ corresponding to said selected data instance and the K^{th} preceding point ‘Tₙ₋ₖ’;
for each known event, determining a respective distance versus time function from the determined distances and time-stamps associated with each data instance; and
for each known event, determining the morphology parameters associated with the respective distance versus time function.

4. The method according to claim 2, wherein said distance threshold is determined according to:
γ=2D*t*s(h)
where t denotes time h denotes a given in confidence percentage s(h) denotes the student distribution and D denotes the mass diffusivity.

5. The method according to claim 2, wherein said distance threshold is determined according to a distribution function of the distances of the points in the attribute space, from the point of origin, after a predetermined period of time and selecting distance with the highest probability.

6. The method according to claim 2, wherein said known event is indicated and classified by an expert.

7. The method according to claim 2, wherein said time difference ‘K’ is determined to correspond to one of the mean value and the median value of the distance between a pair of data points.

8. The method according to claim 2, wherein said time difference ‘K’ is determined based on classification performance.

9. The method according to claim 1, wherein a decision tree is employed when classifying and event,
wherein nodes in said decision tree relates to respective morphology parameters and a source decision node is related to said threshold.

10. The method according to claim 7, wherein the classification of said at least one event is mapped into an Event Classification Table.

11. A system for detecting and classifying an event comprising:
a database, for storing a plurality of data instance, each data instance including values associated with a measured at least one selected attribute, said values defining the location of a point corresponding to each data instance in an attribute space, at least some of the dimensions of said attribute space being each associated with respective one of said at least one selected attribute, each of said data instances being further associated with a time-stamp; and
an event detector and classifier, determining the distance in said attributes space, between each point corresponding to a selected data instance and a K^{th} preceding point, said event detector and classifier determining a distance versus time function from the determined distances and said time-stamps associated with each of the selected instance, said event detector and classifier detecting the occurrence of an event according to a distance threshold of said distances in said distance versus time function, said event detector and classifier further determining the morphology parameters of the distance versus time graph when an event is detected and classifying said event according to the determined morphology parameters of the distance versus time graph.

12. The system according to claim 11, wherein said morphology parameters include at least one of:
Length to height ratio;
Peak Ratio;
Symmetry Ratio;
Time Before Event;
Neighboring Density; and
Event Trajectory.

13. The system according to claim 11, wherein said database further storing a plurality of data instance associated with at least one known event, and
wherein said event detector and classifier further determines a time difference ‘K’ between a pair of data instances and determining a distance threshold, said event detector and classifier further determines the distance in said attributes space between each selected point and the K^{th} preceding record, for each known event, said event detector and classifier determines a respective distance versus time function from the determined distances and time-stamps associated with each data instance, for each known event, said event detector and classifier determines the morphology parameters associated with the respective distance versus time function.

14. The system according to claim 12, wherein said distance threshold is determined according to:
γ=2D*t*s(h)
where t denotes time h denotes a given in confidence percentage s(h) denotes the student distribution and D denotes mass diffusivity.

15. The system according to claim 12, wherein said distance threshold is determined according to a distribution function of the distances of the points in the attribute space, from the point of origin, after a predetermined period of time and selecting distance with the highest probability.

16. The system according to claim 12, wherein said known event is indicated and classified by an expert.

17. The system according to claim 12, wherein said time difference ‘K’ is determined to correspond to one of the mean value and the median value of the distance between a pair of data instance.

18. The system according to claim 12, wherein said time difference ‘K’ is determined based on classification performance.

19. The system according to claim 11, wherein a decision tree is employed when classifying and event,
wherein nodes in said decision tree relates to respective morphology parameters and a source decision node is related to said threshold.

20. The system according to claim 17, wherein the classification of said at least one event is mapped into an Event Classification Table.

21. The system according to claim 11, further including at least one at least one sensor unit, coupled with said event detector and classifier and with said database, each of said at least one sensor unit including at least one respective sensor, each of said at least one respective sensor measuring at least a respective one of said at least one physical attribute.

22. The system according to claim 11, further including and event monitoring and management system, coupled with said event detector and classifier.
